(19) United States
(12) Patent Application Publication
(10) Pub. No.: US 2026/0120615 A1
(43) Pub. Date: Apr. 30, 2026

(54) DISPLAY DEVICE INCLUDING COMPENSATION VALUE CORRECTOR CIRCUIT, ELECTRONIC DEVICE, AND DRIVING METHOD THEREOF

(71) Applicant: SAMSUNG DISPLAY CO., LTD., YONGIN-SI (KR)

(72) Inventor: Jong Kwang HWANG, Yongin-si (KR)

(21) Appl. No.: 19/335,163

(22) Filed: Sep. 22, 2025

(30) Foreign Application Priority Data
Oct. 25, 2024 (KR) 10-2024-0147840

(51) Int. Cl. G09G 3/20

(52) U.S. Cl. CPC G09G 3/2092; G09G 2300/0842; G09G 2310/08; G09G 2320/0276; G09G 2330/021; G09G 2360/16

(57) ABSTRACT

A display device includes a compensation value corrector circuit configured to calculate final compensation values by applying weights, based on input grayscales of an image frame, to reference compensation values. A display device includes a timing controller circuit configured to generate output grayscales by applying the final compensation values to the input grayscales. The compensation value corrector circuit is configured to be switched-off based on the weights. The output grayscales are set to be equal to the input grayscales when the compensation value corrector circuit is configured to be switched-off.

### CROSS-REFERENCE TO RELATED APPLICATION

The application claims priority under 35 U.S.C. § 119 to Korean Patent Application No. 10-2024-0147840, filed on Oct. 25, 2024, in the Korean Intellectual Property Office, the disclosure of which is incorporated by reference herein in its entirety.

### TECHNICAL FIELD

The present invention relates to a display device and, more specifically, to a display device including compensation value corrector circuit, an electronic device, and a method of driving the same.

### DISCUSSION

With recent developments in information technology, the importance of a display device as a communication medium is highlighted. In response to the developments, the use of display devices such as liquid crystal display devices and organic light emitting display devices is increasing.

As display panels become larger in size, the distribution of pixels on the display panel may become an issue. For example, the characteristics of a driving transistor or a light emitting element included in each pixel of the display panel may vary, resulting in stain-like artifacts (referred to herein as “stains”) in a displayed image.

### SUMMARY

According to an embodiment of the disclosure, a display device includes a compensation value corrector circuit configured to calculate final compensation values by applying weights, based on input grayscales of an image frame, to reference compensation values. A display device includes a timing controller circuit configured to generate output grayscales by applying the final compensation values to the input grayscales. The compensation value corrector circuit is configured to be switched-off based on the weights. The output grayscales are set to be equal to the input grayscales when the compensation value corrector circuit is configured to be switched-off.

In embodiments, the compensation value corrector circuit may include a first weight calculator circuit configured to generate first weights based on an input brightness value.

In embodiments, a display device may comprise a memory. A memory may include reference weights corresponding to reference brightness values. The first weight calculator circuit may be configured to provide the reference weights corresponding to the input brightness value as the first weights, when the input brightness value may be equal to any one of the reference brightness values. When the input brightness value may be different from the reference brightness values, the first weight calculator circuit may be configured to interpolate the reference weights corresponding to two of the reference brightness values closest to the input brightness value. An interpolated value of the reference weights may be provided as the first weights.

In embodiments, the compensation value corrector circuit may include a second weight calculator circuit configured to calculate second weights based on the input grayscales and based on the first weights.

In embodiments, the first weights may correspond to reference grayscales, respectively. The second weight calculator circuit may be configured to provide any one of the first weights corresponding to any one of the input grayscales as any one of the second weights, when any one of the input grayscales may be equal to any one of the reference grayscales. When the input grayscales may be different from the reference grayscales, the second weight calculator circuit may be configured to interpolate the first weights corresponding to two of the reference grayscales closest to any one of the input grayscales. An interpolated value of the first weights may be provided as any one of the second weights.

In embodiments, the compensation value corrector circuit may include a final compensation value calculator circuit configured to calculate the final compensation values by applying the second weights to the reference compensation values.

In embodiments, the compensation value corrector circuit may include a switch-off trigger circuit configured to determine whether to switch-off the compensation value corrector circuit, based on the second weights.

In embodiments, the switch-off trigger circuit may be configured to switch-off the compensation value corrector circuit when at least one of the second weights may be less than or equal to a first reference value.

In embodiments, the compensation value corrector circuit may include a counting circuit configured to count a number of the second weights that may be less than or equal to the first reference value. The compensation value corrector circuit may include a representative grayscale calculator circuit configured to calculate a representative grayscale of the input grayscales. The counting circuit may be configured to provide a count value. The switch-off trigger circuit may be configured to switch-off the compensation value corrector circuit when the count value may be greater than a second reference value. The switch-off trigger circuit may be configured to switch-off the compensation value corrector circuit when any one of the second weights corresponding to the representative grayscale may be less than or equal to the first reference value.

According to embodiments of the disclosure, a driving method of a display device includes receiving an image frame including input grayscales. The driving method of a display device includes calculating final compensation values by applying weights, based on the input grayscales, to reference compensation values. The driving method of a display device includes generating output grayscales by applying the final compensation values to the input grayscales. The driving method of a display device includes generating data voltages corresponding to the output grayscales. The driving method of a display device includes writing the data voltages into pixels. The calculating of the final compensation values is omitted based on the weights. The output grayscales are set to be equal to the input grayscales, when the calculating of the final compensation values is omitted.

In embodiments, the calculating of the final compensation values may include generating first weights based on an input brightness value.

In embodiments, the calculating of the final compensation values may include receiving reference weights corresponding to reference brightness values. The calculating of the final compensation values may include providing the reference weights corresponding to the input brightness value as the first weights, when the input brightness value may be equal to any one of the reference brightness values. The calculating of the final compensation values may include interpolating reference weights corresponding to two of the reference brightness values closest to the input brightness value, when the input brightness value may be different from the reference brightness values, and providing an interpolated value of the reference weights as the first weights.

In embodiments, the calculating of the final compensation values may include calculating second weights based on the input grayscales and based on the first weights.

In embodiments, the first weights may correspond to reference grayscales, respectively. The calculating of the final compensation values may include providing any one of the first weights corresponding to any one of the input grayscales as any one of the second weights, when any one of the input grayscales is equal to any one of the reference grayscales. The calculating of the final compensation values may include interpolating the first weights corresponding to two of the reference grayscales closest to any one of the input grayscales, when the input grayscales may be different from the reference grayscales, and providing an interpolated value of the first weights as any one of the second weights.

In embodiments, the calculating of the final compensation values may include calculating the final compensation values by applying the second weights to the reference compensation values.

In embodiments, the calculating of the final compensation values may include determining whether to omit the calculating of the final compensation values, based on the second weights.

In embodiments, the determining of whether to omit may include omitting the calculating of the final compensation values when at least one of the second weights may be less than or equal to a first reference value.

In embodiments, the calculating of the final compensation values may include providing a count value by counting a number of the second weights that may be less than or equal to the first reference value. The determining of whether to omit may include omitting the calculating of the final compensation values when the count value may be greater than a second reference value.

In embodiments, the calculating of the final compensation values may include calculating a representative grayscale of the input grayscales. The determining of whether to omit may include omitting the calculating of the final compensation values when any one of the second weights corresponding to the representative grayscale may be less than or equal to the first reference value.

According to embodiments of the disclosure, an electronic device includes a processor configured to provide image frames including input grayscales. The electronic device includes a display device configured to sequentially display the image frames received from the processor. The display device includes a compensation value corrector circuit configured to calculate final compensation values, by applying weights based on the input grayscales, to reference compensation values. The display device includes a timing controller circuit configured to generate output grayscales by applying the final compensation values to the input grayscales. The display device includes a data driver circuit configured to output data voltages corresponding to the output grayscales to data lines. The display device includes a display panel including a plurality of pixels configured to receive the data voltages through the data lines. The compensation value corrector circuit is configured to be switched-off based on the weights. The output grayscales are set to be equal to the input grayscales when the compensation value corrector circuit is switched-off.

### BRIEF DESCRIPTION OF THE DRAWINGS

The above and other features of the disclosure will become more apparent from the following description of the embodiments, taken in conjunction with the accompanying drawings, in which:

FIG. 1 is a schematic diagram illustrating a display device according to an embodiment of the present invention.

FIG. 2 is a circuit diagram illustrating a pixel according to an embodiment of the present invention.

FIG. 3 is a block diagram illustrating a compensation value corrector according to an embodiment of the present invention.

FIG. 4 is a graph corresponding to a first weight calculator according to an embodiment of the present invention.

FIG. 5 is a graph corresponding to a second weight calculator according to an embodiment of the present invention.

FIG. 6 is a table corresponding to a switch-off trigger according to an embodiment of the present invention.

FIG. 7 is a block diagram illustrating a compensation value corrector according to an embodiment of the present invention.

FIG. 8 is a block diagram illustrating a compensation value corrector according to an embodiment of the present invention.

FIG. 9 is a block diagram of an electronic device according to embodiments of the present invention.

### DETAILED DESCRIPTION OF THE ILLUSTRATED EMBODIMENTS

Hereinafter, various embodiments of the present invention will now be described more fully with reference to the accompanying drawings, in which embodiments of the invention are shown. In the following description, portions necessary for understanding an operation according to the disclosure may be described, and descriptions of other portions may be omitted. In addition, the disclosure may be embodied in other forms without being necessarily limited to the embodiments described herein. The embodiments described herein are provided so that this disclosure will be thorough and complete, and will fully convey the scope of the invention to those skilled in the art.

Hereinafter, same reference numerals are used for the same components in the drawings, and redundant descriptions of the same components may be omitted. To the extent that an element is not described in detail with respect to a figure, it may be understood that the element is at least similar to a corresponding element that has been described elsewhere within the present disclosure.

In embodiments, while each drawing may represent one or more particular embodiments of the present disclosure, drawn to scale, such that the relative lengths, thicknesses, and angles can be inferred therefrom, it is to be understood that the present invention is not necessarily limited to the relative lengths, thicknesses, and angles shown. Changes to these values may be made within the spirit and scope of the present disclosure, for example, to allow for manufacturing limitations and the like.

Embodiments of the present disclosure are described with the understanding that, the expression “is the same” may mean “substantially the same”. For example, “substantially” might be omitted.

Traditionally, a display device includes a display panel. An image may be displayed on the display panel. However, stain-like artifacts (referred to herein as “stains”) may appear in a displayed image. For example, the displayed image may include visible discoloration, marks, spots, etc.

To resolve these challenges, output grayscales may be produced by compensating input grayscales. For example, the input grayscales may be compensated by applying a weight to the input grayscales. In an embodiment, the compensation may be done with minimal power consumption by occasionally switching off the calculation of compensation values.

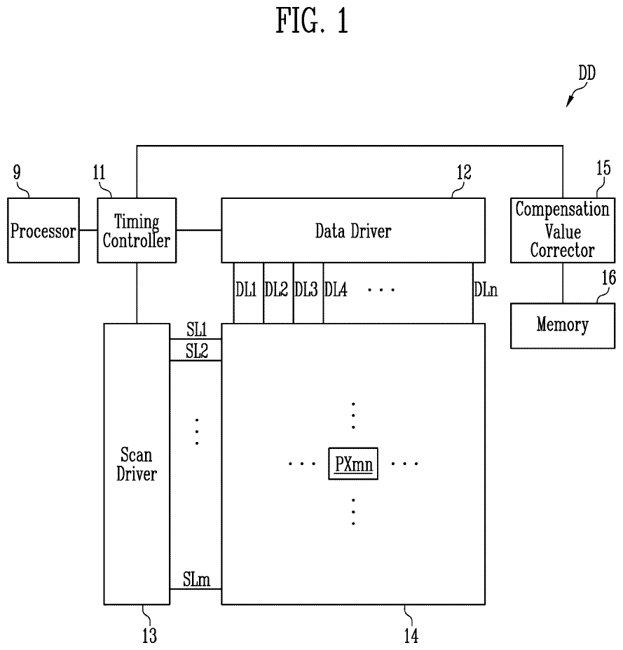

FIG. 1 is a schematic diagram illustrating a display device according to an embodiment of the present invention.

Referring to FIG. 1, a display device DD according to an embodiment of the present invention may include a processor 9, a timing controller 11, a data driver 12, a scan driver 13, a display panel 14, a compensation value corrector 15, and a memory 16. In embodiments, a timing controller 11 may include a timing controller circuit, a data driver 12 may include a data driver circuit, a scan driver 13 may include a scan driver circuit, a compensation value corrector 15 may include a compensation value corrector circuit.

The processor 9 may provide input grayscales and control signals for each image (or image frame). The processor 9 may correspond to a GPU (Graphics Processing Unit), a CPU (Central Processing Unit), an AP (Application Processor), or the like. The control signals may include a vertical synchronization signal, a horizontal synchronization signal, a data enable signal, or the like.

The vertical synchronization signal may include a plurality of pulses, and may indicate the end of a previous frame period and the start of a current frame period, based on a point of time at which each pulse occurs. An interval between adjacent pulses of the vertical synchronization signal may correspond to one frame period. The horizontal synchronization signal may include a plurality of pulses, and may indicate the end of a previous horizontal period and the start of a new horizontal period, based on a point of time at which each pulse occurs. An interval between adjacent pulses of the horizontal synchronization signal may correspond to one horizontal period. The data enabling signal may have an enabling level for specific horizontal periods and a disabling level for the remaining periods. When the data enabling signal is at the enabling level, the signal level may indicate that the input grayscales are supplied in corresponding horizontal periods.

The memory 16 may include reference compensation values. The compensation value corrector 15 may calculate final compensation values by applying weights, based on the input grayscales, to the reference compensation values. The timing controller 11 may generate output grayscales by applying the final compensation values to the input grayscales.

As the display panel 14 becomes larger in size and/or surface area, the distribution of pixels PXmn on the display panel 14 may become a problem. For example, the characteristics of a driving transistor or a light emitting element included in each pixel PXmn may be different, resulting in stains in a displayed image. In embodiments, when a monochrome image of a specific input grayscale is displayed on the display panel 14 at a specific brightness value and captured, stains may be visible.

In embodiments, a brightness value of the display device DD may be the luminance of light emitted from pixels set to a maximum grayscale (for example, 255 grayscales when grayscales are expressed in 8 bits). For example, the brightness value may be the luminance of white light generated when all pixels of the display panel 14 emit light corresponding to a white grayscale. The unit of the luminance may be nits. The brightness value may be set manually by the user's operation on the display device DD, or automatically by an algorithm linked to a light sensor or the like. For example, a maximum brightness value may be 2175 nits, and a minimum brightness value may be 4 nits. The maximum and minimum values of the brightness value may be set differently depending on a product. In an embodiment, the maximum brightness value may be different from 2175 nits, and a minimum brightness value may be different from 4 nits. In an embodiment with the same grayscale, because a data voltage varies depending on the brightness value, the luminance of light emitted from the pixel PXmn may also vary.

To solve the problem of stains occurring in a monochrome image of a specific input grayscale, it may be necessary to use an output grayscale obtained by compensating the input grayscale. For example, the output grayscale may be a value obtained by adding a compensation value to the input grayscale. The compensation value may be obtained by using a camera, luminance meter, or the like to capture and confirm a monochrome image with stains (for e.g., a monochromatic image composed of input grayscale) and a monochrome image without stains (for e.g., a monochromatic image composed of output grayscale) during a manufacturing process of the display device DD, and using a grayscale difference between the monochrome images.

In an embodiment, it might not be desirable to store compensation values for all input grayscales in advance in the memory 16 at all brightness values, because it requires a very large memory capacity. In embodiments, takt time may increase as the camera or luminance meter is used to capture an image and confirm the presence of stains. Therefore, it may be desirable to store reference compensation values for a reference input grayscale in advance in the memory 16 at a reference brightness value, and to utilize the final compensation values obtained by applying weights to the reference compensation values for the remaining brightness values and the remaining input grayscales. For example, a final compensation value may be defined as a value obtained by multiplying a reference compensation value by a weight. The weight may range from 0 to 4, but is not necessarily limited thereto and may vary depending on a product.

The memory 16 may include reference weights corresponding to reference brightness values. The reference brightness values may be some of brightness values that the display device DD can display. As described above, it might not desirable to store the weights for all cases in the memory 16 because it may require a large memory and takt time.

In an embodiment, the timing controller 11 may generate the output grayscales by applying the final compensation values to the input grayscales. The timing controller 11 may provide the output grayscales to the data driver 12. The timing controller 11 may provide a clock signal, a scan start signal, and the like to the scan driver 13.

The data driver 12 may generate data voltages to be provided to data lines DL1, DL2, DL3, DL4, . . . , and DLn using the output grayscales received from the timing controller 11, where n may be an integer greater than 0.

The scan driver 13 may generate scan signals to be provided to scan lines SL1, SL2, . . . , and SLm using the clock signal, the scan start signal, or the like received from the timing controller 11, where m may be an integer greater than 0.

The scan driver 13 may sequentially supply the scan signals having a turn-on level pulse to the scan lines SL1, SL2, . . . , and SLm. For example, the scan driver 13 may supply the scan signals of a turn-on level to the scan lines with a cycle corresponding to the cycle of the horizontal synchronization signal. The scan driver 13 may include scan stages configured in the form of a shift register. The scan driver 13 may generate the scan signals by sequentially transmitting the scan start signal in the form of the turn-on level pulse to the next scan stage under the control of the clock signal.

The display panel 14 may display an image. The display panel 14 may include a plurality of pixels that receive the data voltages through the data lines DL1 to DLn. Each pixel may be connected to a corresponding data line and scan line. For example, a pixel PXmn may be connected to an m-th scan line and a n-th data line. The pixels may include pixels emitting light of a first color, pixels emitting light of a second color, and pixels emitting light of a third color. The first color, the second color, and the third color may be different colors. For example, the first color may be one of red, green, and blue, the second color may be one of red, green, and blue other than the first color, and the third color may be one of red, green, and blue other than the first color and the second color. In addition, instead of red, green, and blue, magenta, cyan, and yellow may be used as the first to third colors. However, in embodiments, for convenience of description, it may be assumed that the first color, the second color, and the third color are red, green, and blue.

According to an embodiment, at least two of the processor 9, the timing controller 11, the data driver 12, the scan driver 13, the compensation value corrector 15, and the memory 16 may be configured as a single integrated circuit. In embodiments, the transmission and reception relationships of various data between the processor 9, the timing controller 11, the data driver 12, the scan driver 13, the compensation value corrector 15, and the memory 16 may be modified depending on the type of the display device DD.

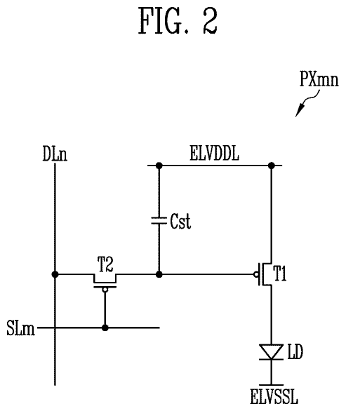

FIG. 2 is a circuit diagram illustrating a pixel according to an embodiment of the present invention.

Referring to FIG. 2, an example of a pixel PXmn is shown. Because other pixels may also have substantially the same configuration, redundant descriptions of the same components may be omitted. To the extent that an element is not described in detail with respect to a figure, it may be understood that the element is at least similar to a corresponding element that has been described elsewhere within the present disclosure.

A transistor T1 may have a gate electrode connected to a second electrode of a storage capacitor Cst, a first electrode connected to a first power source line ELVDDL, and a second electrode connected to an anode of a light emitting diode LD. The transistor T1 may be referred to as a driving transistor. A first power source voltage may be applied to the first power source line ELVDDL.

A transistor T2 may have a gate electrode connected to an m-th scan line SLm, a first electrode connected to a n-th data line DLn, and a second electrode connected to the second electrode of the storage capacitor Cst.

A first electrode of the storage capacitor Cst may be connected to the first power source line ELVDDL, and the second electrode of the storage capacitor Cst may be connected to the gate electrode of the transistor T1.

The light emitting diode LD may have the anode connected to the second electrode of the transistor T1 and a cathode connected to a second power source line ELVSSL. A second power source voltage may be applied to the second power source line ELVSSL. During an emission period of the light emitting diode LD, the first power source voltage may be greater than the second power source voltage.

In some embodiments, the transistors T1 and T2 are shown as P-type transistors, but those skilled in the art will be able to replace at least one of the P-type transistors with an N-type transistor by reversing the polarity of a signal.

When a scan signal of a turn-on level is applied to the m-th scan line SLm, the transistor T2 may be turned on. In an embodiment, a data voltage supplied to the n-th data line DLn may be stored in the storage capacitor Cst. In embodiments, a driving current may flow through the transistor T1, in response to a gate-source voltage difference maintained by the storage capacitor Cst. The driving current may flow through the first power source line ELVDDL, the transistor T1, the light emitting diode LD, and the second power source line ELVSSL. The light-emitting diode LD may emit light with a luminance corresponding to the amount of the driving current.

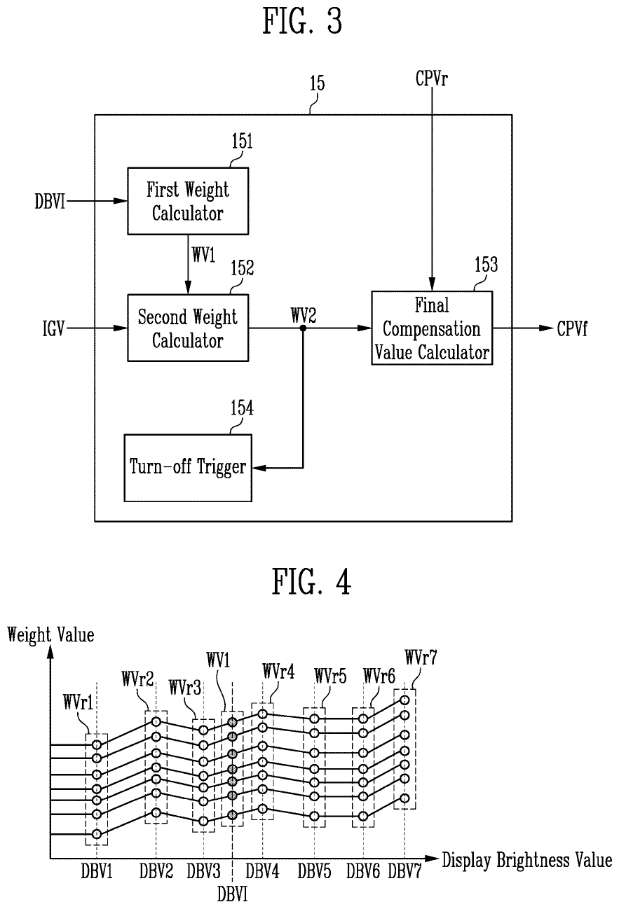

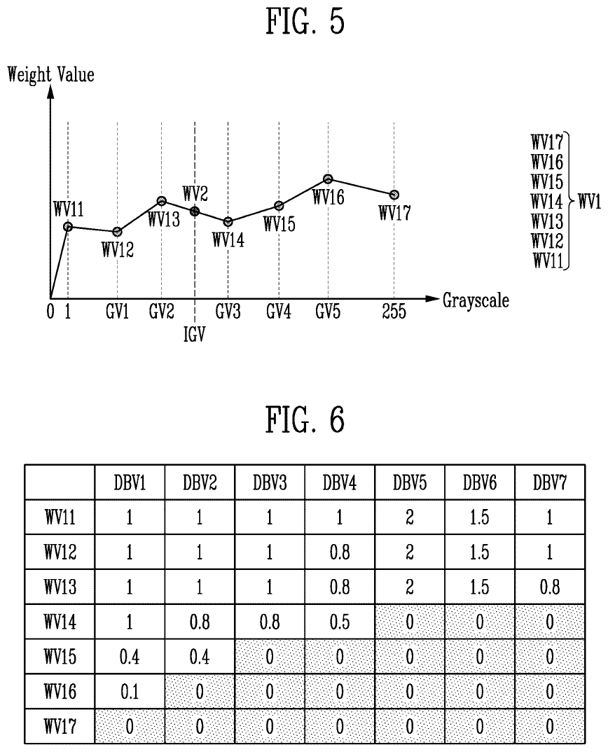

FIG. 3 is a block diagram illustrating a compensation value corrector according to an embodiment of the present invention. FIG. 4 is a graph corresponding to a first weight calculator according to an embodiment of the present invention. FIG. 5 is a graph corresponding to a second weight calculator according to an embodiment of the present invention. FIG. 6 is a table corresponding to a turn-off trigger according to an embodiment of the present invention. In embodiments, the turn-off trigger may be a switch-off trigger circuit.

Referring to FIG. 3, the compensation value corrector 15 according to an embodiment of the present invention may include a first weight calculator 151, a second weight calculator 152, a final compensation value calculator 153, and a turn-off trigger 154. In embodiments, a compensation value corrector 15 may include a compensation value corrector circuit. A first weight calculator 151 may include a first weight calculator circuit. A second weight calculator 152 may include a second weight calculator circuit. A final compensation value calculator 153 may include a final compensation value calculator circuit. A turn-off trigger 154 may include a turn-off trigger circuit.

The compensation value corrector 15 may be turned off based on the weights, and when the compensation value corrector 15 is turned off, the output grayscales may be set to be the same as input grayscales IGV. For example, the output grayscales may be set to be equal to the input grayscales when the compensation value corrector circuit may be configured to be switched-off. In embodiments, the value corrector 15 is turned off may mean that the value corrector 15 is switched-off.

The first weight calculator 151 may generate first weights WV1 based on an input brightness value DBV1. As described above, the input brightness value DBV1 may be set manually by the user's operation on the display device DD, or automatically by an algorithm linked to a light sensor or the like.

Referring to FIG. 4, an example graph is shown where the horizontal axis represents display brightness values and the vertical axis represents weights. The memory 16 may include reference weights WVr1, WVr2, WVr3, WVr4, WVr5, WVr6, and WVr7 corresponding to reference brightness values DBV1, DBV2, DBV3, DBV4, DBV5, DBV6, and DBV7. In embodiments, the memory 16 may be shown as including a plurality of reference weights (for example, 7) for each of the reference brightness values DBV1 to DBV7. In some embodiments, the memory 16 may be configured to include only one reference weight for a specific input grayscale for each of the reference brightness values DBV1 to DBV7. In embodiments, the remaining six reference weights may be calculated by an algorithm to be proportional to the grayscale (or a voltage corresponding to the grayscale).

The first weight calculator 151 may provide the reference weights WVr1 to WVr7 corresponding to the input brightness value DBV1 as the first weights WV1, when the input brightness value DBV1 is equal to any one of the reference brightness values DBV1 to DBV7.

In embodiments, when the input brightness value DBV1 is different from the reference brightness values DBV1 to DBV7, the first weight calculator 151 may interpolate reference weights WVr3 and WVr4 corresponding to two reference brightness values DBV3 and DBV4 closest to the input brightness value DBV1 and provide the interpolated values as the first weights WV1.

The two reference brightness values DBV3 and DBV4 closest to the input brightness value DBV1 may mean a reference brightness value DBV3 that is smaller than the input brightness value DBV1 but has the smallest difference in the brightness value, and a reference brightness value DBV4 that is larger than the input brightness value DBV1 but has the smallest difference in the brightness value.

The second weight calculator 152 may calculate second weights WV2 based on the input grayscales IGV and the first weights WV1.

Referring to FIG. 5, an example graph is shown where the horizontal axis represents a grayscale and the vertical axis represents weight (value). The first weights WV1 may include a plurality of weights WV11, WV12, WV13, WV14, WV15, WV16, and WV17 corresponding to reference grayscales 1, GV1, GV2, GV3, GV4, GV5, and 255. In embodiments, grayscales 0 to 255 are expressed in 8 bits as an example, but the number of grayscales is not necessarily limited to 256. In embodiments, although the horizontal axis of the graph represents the grayscale, it may also represent voltage values corresponding to the grayscale.

When the input grayscale IGV is equal to any one of the reference grayscales 1, GV1, GV2, GV3, GV4, GV5, and 255, the second weight calculator 152 may provide a first weight WV11, WV12, WV13, WV14, WV15, WV16, or WV17 corresponding to the input grayscale IGV as a second weight WV2.

In embodiments, when the input grayscale IGV is different from the reference grayscales 1, GV1, GV2, GV3, GV4, GV5, and 255, the second weight calculator 152 may interpolate first weights WV13 and WV14 corresponding to two reference grayscales GV2 and GV3 closest to the input grayscale IGV, and provide the interpolated value as the second weight WV2. For example, the interpolation may be calculated according to the following Mathematical Expression 1.

$$WV 2 = WV 13 + \frac{( W V 14 - WV 13 ) \times ( IGV - GV 2 )}{( G V 3 - G V 2 )} \qquad [ Mathematical Expression 1 ]$$

The two reference grayscales GV2 and GV3 closest to the input grayscale IGV may mean a reference grayscale GV2 that is smaller than the input grayscale IGV but has the smallest difference in grayscale, and a reference grayscale GV3 that is larger than the input grayscale IGV but has the smallest difference in grayscale.

The final compensation value calculator 153 may calculate final compensation values CPVf by applying the second weights WV2 to reference compensation values CPVr. For example, the second weights WV2 may be real numbers greater than or equal to 0, and the final compensation value calculator 153 may calculate the final compensation values CPVf by multiplying corresponding second weights WV2 to the reference compensation values CPVr.

As described above, the timing controller 11 may generate the output grayscales by applying the final compensation values CPVf to the input grayscales IGV. For example, the timing controller 11 may generate the output grayscales by adding the final compensation values CPVf to the input grayscales IGV.

In an embodiment, there may be a problem if the second weights WV2 include 0. If the second weight WV2 is 0, a final compensation value CPVf may be 0 regardless of a value of a reference compensation value CPVr. In an embodiment, the operation of the compensation value corrector 15 may cause unnecessary power consumption.

In an embodiment of the present invention, because the compensation value corrector 15 includes the turn-off trigger 154, the compensation value corrector 15 may be turned off based on the weights when required. For example, the display device DD may omit the calculating the final compensation values CPVf. In an embodiment, the output grayscales may be set to be the same as the input grayscales IGV. For example, if the final compensation values CPVf are set to a default value (for example, 0), the output grayscales may be set to be the same as the input grayscales IGV.

In embodiments, because consecutive image frames may have similar grayscales, there may be an advantage in that significant power may be saved if the compensation value corrector 15 does not operate during consecutive image frames. For example, the compensation value corrector 15 may be turned-off or switched-off.

The turn-off trigger 154 may determine whether to turn off the compensation value corrector 15 based on the second weights WV2. For example, when at least one of the second weights WV2 is less than or equal to a first reference value, the turn-off trigger 154 may turn off the compensation value corrector 15. For example, the first reference value may be 0. In embodiments, the first reference value may be set to a value greater than 0 depending on a product.

Referring to FIG. 6, a table of the first weights WV11 to WV17 for the reference brightness values DBV1 to DBV7 is shown as an example. As described above, the first weights WV11, WV12, WV13, WV14, WV15, WV16, and WV17 may correspond to the reference grayscales 1, GV1, GV2, GV3, GV4, GV5, and 255, respectively.

Referring to the table in FIG. 6, it may be confirmed that the first weights WV11 to WV17 may be set to 0 for some brightness and some grayscale. For example, the second weight WV2 interpolated in a corresponding grayscale section may be 0. In embodiments, the turn-off trigger 154 may reduce power consumption by turning off the compensation value corrector 15.

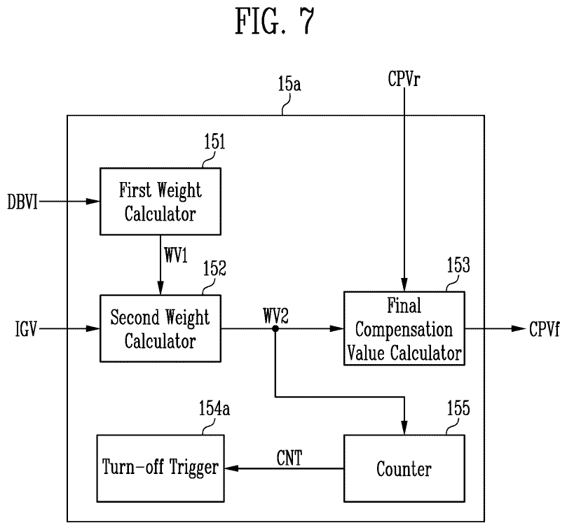

FIG. 7 is a block diagram illustrating a compensation value corrector according to an embodiment of the present invention.

Referring to FIG. 7, a compensation value corrector 15a according to an embodiment of the present invention may further include a counter 155.

The counter 155 may count the number of second weights WV2 that are less than or equal to the first reference value and provide a count value CNT.

A turn-off trigger 154a may turn off the compensation value corrector 15a when the count value CNT is greater than a second reference value. For example, when the first reference value is 0 and the second reference value is 10, if the number of second weights WV2 having a value of 0 is 11 or more, the turn-off trigger 154a may turn off the compensation value corrector 15a. The second reference value may be set in various ways depending on a product. In an embodiment, the turn-off trigger 154a may be a switch-off trigger circuit, which may switch-off the compensation value corrector 15a.

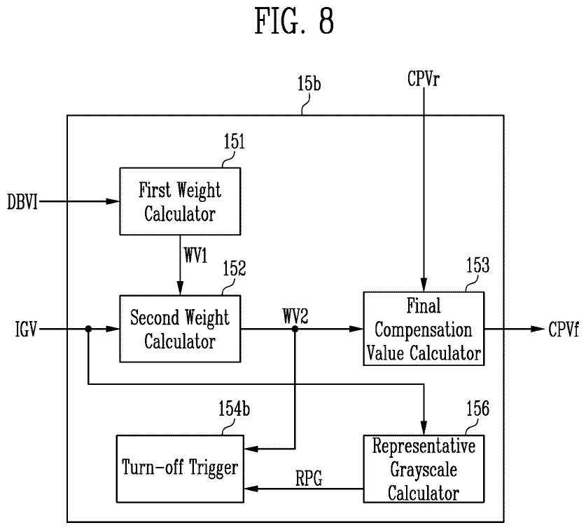

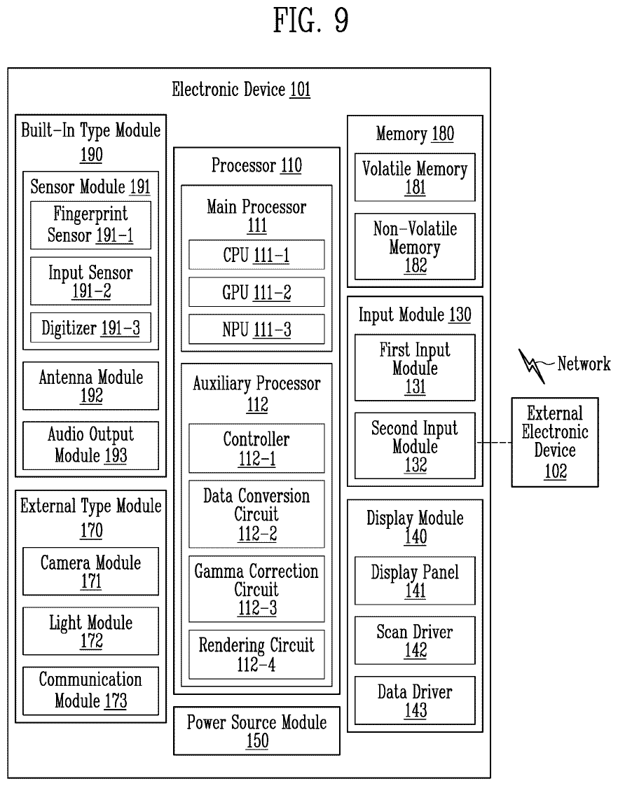

FIG. 8 is a block diagram illustrating a compensation value corrector according to an embodiment of the present invention.

Referring to FIG. 8, a compensation value corrector 15b according to an embodiment of the present invention may further include a representative grayscale calculator 156.

The representative grayscale calculator 156 may calculate a representative grayscale RPG of the input grayscales IGV. For example, the representative grayscale RPG may be an average value of the input grayscales IGV. In some embodiments, the representative grayscale RPG may be an average value of values obtained by applying different weights to the input grayscales IGV for each color. In some embodiments, the representative grayscale RPG may be an average value of values obtained by applying different weights to the input grayscale IGV for each grayscale section. For example, the representative grayscale RPG may be sufficient as a value that represents the image frame, and might not be limited by a special algorithm. The representative grayscale RPG may have a value greater than or equal to a minimum grayscale and less than or equal to a maximum grayscale. For example, if the grayscale is expressed in 8 bits, the range of the representative grayscale RPG may be from 0 to 255.

When the second weight WV2 corresponding to the representative grayscale RPG among the second weights WV2 is less than or equal to the first reference value, the turn-off trigger 154b may turn off the compensation value corrector 15b. As described above, the first reference value may be 0. In some embodiments, the first reference value may be set to a value greater than 0 depending on a product. In an embodiment, the turn-off trigger 154b may be a switch-off trigger circuit, which may switch-off the compensation value corrector 15b.

FIG. 9 is a block diagram of an electronic device according to embodiments of the present invention.

An electronic device 101 may output various information through a display module 140 within an operating system. When a processor 110 executes an application stored in a memory 180, the display module 140 may provide application information to a user through a display panel 141.

The processor 110 may obtain an external input through an input module 130 or a sensor module 191 and execute an application corresponding to the external input. For example, when the user selects a camera icon displayed on the display panel 141, the processor 110 may obtain a user input through an input sensor 191-2 and activate a camera module 171. The processor 110 may transmit image data corresponding to the captured image obtained through the camera module 171 to the display module 140. The display module 140 may display an image corresponding to the captured image through the display panel 141.

As an example, when personal information authentication is executed in the display module 140, a fingerprint sensor 191-1 may obtain input fingerprint information as input data. The processor 110 may compare the input data obtained through the fingerprint sensor 191-1 with authentication data stored in the memory 180, and execute an application according to the comparison result. The display module 140 may display information executed according to the logic of the application through the display panel 141.

As an example, when a music streaming icon displayed on the display module 140 is selected, the processor 110 may obtain a user input through the input sensor 191-2 and activate a music streaming application stored in the memory 180. When a music play command is input from the music streaming application, the processor 110 may activate an audio output module 193 to provide audio information corresponding to the music play command to the user.

Some operations of the electronic device 101 are briefly described above. Below, the configuration of the electronic device 101 will be described in more detail. Some of the components of the electronic device 101 may be integrated and provided as one component, or one component may be provided separately as two or more components.

Referring to FIG. 9, the electronic device 101 may communicate with an external electronic device 102 through a network (for example, a short-range wireless communication network or a long-range wireless communication network). According to an embodiment, the electronic device 101 may include the processor 110, the memory 180, the input module 130, the display module 140, a power source module 150, a built-in type module 190, and an external type module 170. According to an embodiment, in the electronic device 101, at least one of the components described above may be omitted, or one or more other components may be added. According to an embodiment, some of the components (for example, the sensor module 191, an antenna module 192, or the audio output module 193) may be integrated into another component (for example, integrated into the display module 140).

The processor 110 may execute software to control at least one other component (for example, hardware or software component) of the electronic device 101 connected to the processor 110 and perform various data processing or operations. According to an embodiment, as at least part of the data processing or operations, the processor 110 may store a command or data received from other components (for example, the input module 130, the sensor module 191, or a communication module 173) in a volatile memory 181, process the command or data stored in the volatile memory 181, and store the resulting data in a non-volatile memory 182.

The processor 110 may include a main processor 111 and an auxiliary processor 112. The main processor 111 may include one or more of a central processing unit (CPU) 111-1 and an application processor (AP). The main processor 111 may further include one or more of a graphics processing unit (GPU) 111-2, a communication processor (CP), and an image signal processor (ISP). The main processor 111 may further include a neural network processing unit (NPU) 111-3. The neural network processing unit may be a processor specialized in processing artificial intelligence models, and the artificial intelligence models may be created through machine learning. An artificial intelligence model may include a plurality of artificial neural network layers. An artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks or a combination of two or more of the above, but might not be necessarily limited to the examples described herein. In addition to a hardware structure, the artificial intelligence model may additionally or alternatively include a software structure. At least two of the above-described processing unit and processor may be implemented as an integrated component (for example, a single chip), or may be implemented as independent components (for example, a plurality of chips).

The auxiliary processor 112 may include a controller 112-1. The controller 112-1 may include an interface conversion circuit and a timing control circuit. The controller 112-1 may receive an image signal from the main processor 111, convert the data format of the image signal to match the interface specifications with the display module 140, and output image data. The controller 112-1 may output various control signals necessary for driving the display module 140.

The auxiliary processor 112 may further include a data conversion circuit 112-2, a gamma correction circuit 112-3, a rendering circuit 112-4, and the like. The data conversion circuit 112-2 may receive the image data from the controller 112-1, compensate for the image data so that an image is displayed at a desired luminance according to the characteristics of the electronic device 101 or user's settings, or convert the image data to reduce power consumption or compensate for an afterimage. The gamma correction circuit 112-3 may convert the image data or a gamma reference voltage so that an image displayed on the electronic device 101 has the desired gamma characteristics. The rendering circuit 112-4 may receive the image data from the controller 112-1 and render the image data by considering a pixel arrangement of the display panel 141 applied to the electronic device 101 and the like. At least one of the data conversion circuit 112-2, the gamma correction circuit 112-3, and the rendering circuit 112-4 may be integrated into another component (for example, the main processor 111 or the controller 112-1). At least one of the data conversion circuit 112-2, the gamma correction circuit 112-3, and the rendering circuit 112-4 may also be integrated into a data driver 143, which will be described in more detail later.

The memory 180 may store various data used by at least one component (for example, the processor 110 or the sensor module 191) of the electronic device 101 and input data or output data for the command related thereto. The memory 180 may include at least one of the volatile memory 181 and the non-volatile memory 182.

The input module 130 may receive a command or data to be used in components of the electronic device 101 (for example, the processor 110, the sensor module 191, or the audio output module 193) from a source external to the electronic device 101 (for example, a user or the external electronic device 102).

The input module 130 may include a first input module 131 through which the command or data is input from the user, and a second input module 132 through which the command or data is input from the external electronic device 102. The first input module 131 may include a microphone, a mouse, a keyboard, keys (for example, buttons), or a pen/stylus (for example, a passive pen/stylus or an active pen/stylus). The second input module 132 may support a designated protocol that can be connected using a wire or wirelessly to the external electronic device 102. According to an embodiment, the second input module 132 may include a high-definition multimedia interface (HDMI), a universal serial bus (USB) interface, an SD card interface, or an audio interface. The second input module 132 may include a connector that can be physically connected to the external electronic device 102, for example, an HDMI connector, a USB connector, an SD card connector, or an audio connector (for example, a headphone connector).

The display module 140 may visually provide information to the user. The display module 140 may include the display panel 141, a scan driver 142, and the data driver 143. The display module 140 may further include a window, a chassis, and a bracket to protect the display panel 141.

The display panel 141 may include a liquid crystal display panel, an organic light emitting display panel, or an inorganic light emitting display panel, and the type of the display panel 141 is not necessarily limited thereto. The display panel 141 may be a rigid type or a flexible type capable of rolling or folding, without being damaged. The display module 140 may further include a supporter supporting the display panel 141, a bracket, a heat dissipation member, or the like.

The scan driver 142 may be mounted on the display panel 141 as a driver chip. In addition, the scan driver 142 may be integrated into the display panel 141. For example, the scan driver 142 may include an amorphous silicon TFT gate driver circuit (ASG), a low-temperature polycrystalline silicon TFT gate driver circuit (LTPS), or an oxide semiconductor TFT gate driver circuit (OSG) built into the display panel 141. The scan driver 1420 may receive a control signal from the controller 112-1 and output scan signals to the display panel 141 in response to the control signal.

The display panel 141 may further include an emission driver. The emission driver may output an emission control signal to the display panel 141 in response to a control signal received from the controller 112-1. The emission driver may be formed separately from the scan driver 142 or may be integrated into the scan driver 142.

The data driver 143 may receive a control signal from the controller 112-1, convert the image data into an analog voltage (for example, a data voltage) in response to the control signal, and output data voltages to the display panel 141.

The data driver 143 may be integrated into other components (for example, the controller 112-1). Functions of the interface conversion circuit and timing control circuit of the controller 112-1 described above may be integrated into the data driver 143.

The display module 140 may further include an emission driver, a voltage generation circuit, and the like. The voltage generation circuit may output various voltages necessary for driving the display panel 141.

The power source module 150 may supply power to components of the electronic device 101. The power source module 150 may include a battery that charges a power source. The battery may include a non-rechargeable primary cell, a rechargeable secondary cell, or a fuel cell. The power source module 150 may include a power management integrated circuit (PMIC). The PMIC may supply optimized power to each of the modules described herein. The power source module 150 may include a wireless power transmission/reception member electrically connected to the battery. The wireless power transmission/reception member may include a plurality of coil-shaped antenna radiators.

The electronic device 101 may further include the built-in type module 190 and the external type module 170. The built-in type module 190 may include the sensor module 191, the antenna module 192, and the audio output module 193. The external type module 170 may include the camera module 171, a light module 172, and the communication module 173.

The sensor module 191 may detect an input by the user's body or an input by the pen/stylus of the first input module 131, and generate an electrical signal or a data value corresponding to the input. The sensor module 191 may include at least one of the fingerprint sensor 191-1, the input sensor 191-2, and a digitizer 191-3.

The fingerprint sensor 191-1 may generate a data value corresponding to the user's fingerprint. The fingerprint sensor 191-1 may include one of an optical fingerprint sensor and a capacitive fingerprint sensor.

The input sensor 191-2 may generate a data value corresponding to coordinate information of the input provided by the user's body or the input by the pen/stylus. The input sensor 191-2 may generate the data value by detecting the amount of change in capacitance caused by the input. The input sensor 191-2 may detect an input by a passive pen/stylus or transmit and receive data with an active pen/stylus.

The input sensor 191-2 may also measure a bio-signal such as blood pressure, moisture, or body fat. For example, when a user touches a part of his or her body to a sensor layer or a sensing panel for a certain period of time, the input sensor 191-2 may detect a bio-signal based on a change in an electric field caused by the part of his or her body and output information desired by the user to the display module 140.

The digitizer 191-3 may generate a data value corresponding to coordinate information of the input provided using a pen/stylus. The digitizer 191-3 may generate the data value by detecting the amount of change in electromagnetic field caused by the input. The digitizer 191-3 may detect an input by a passive pen/stylus or transmit and receive data with an active pen/stylus.

At least one of the fingerprint sensor 191-1, the input sensor 191-2, and the digitizer 191-3 may be implemented as a sensor layer formed on the display panel 141 through a continuous process. The fingerprint sensor 191-1, the input sensor 191-2, and the digitizer 191-3 may be disposed on an upper side of the display panel 141. In an embodiment, any one of the fingerprint sensor 191-1, the input sensor 191-2, and the digitizer 191-3 may be disposed on a lower side of the display panel 141.

At least two of the fingerprint sensor 191-1, the input sensor 191-2, and the digitizer 191-3 may be formed to be integrated into one sensing panel through the same process. When integrated into one sensing panel, the sensing panel may be disposed between the display panel 141 and a window disposed on the top of the display panel 141. According to an embodiment, the sensing panel may be disposed on the window, and the position of the sensing panel is not necessarily limited thereto.

At least one of the fingerprint sensor 191-1, the input sensor 191-2, and the digitizer 191-3 may be built into the display panel 141. For example, at least one of the fingerprint sensor 191-1, the input sensor 191-2, and the digitizer 191-3 may be formed simultaneously through the process of forming elements (for example, a light emitting element, a transistors, and the like) included in the display panel 1410.

In embodiments, the sensor module 191 may generate an electrical signal or a data value corresponding to the internal or external state of the electronic device 101. The sensor module 191 may further include, for example, a gesture sensor, a gyro sensor, a barometric pressure sensor, a magnetic sensor, an acceleration sensor, a grip sensor, a proximity sensor, a color sensor, an IR (infrared) sensor, a biometric sensor, a temperature sensor, a humidity sensor, or an illumination sensor.

The antenna module 192 may include one or more antennas for transmitting signals or power to an external source or receiving signals or power from the external source. According to an embodiment, the communication module 173 may transmit a signal to the external electronic device or receive a signal from the external electronic device through an antenna suitable for a communication method. An antenna pattern of the antenna module 192 may be integrated into a component of the display module 140 (for example, the display panel 141), the input sensor 191-2, or the like.

The audio output module 193 may be a device for outputting an audio signal to a source external to the electronic device 101, and may include, for example, a speaker used for general purposes such as multimedia playback or recording playback, and a receiver used exclusively for receiving phone calls. According to an embodiment, the receiver may be integrated with the speaker or may be formed separately. An audio output pattern of the audio output module 193 may be integrated into the display module 140.

The camera module 171 may capture a still image or a moving image. In an embodiment, the camera module 171 may capture a video. According to an embodiment, the camera module 171 may include one or more lenses, an image sensor, and an image signal processor. The camera module 171 may further include an infrared camera capable of detecting the presence or absence of the user, the user's location, the user's gaze, or the like.

The light module 172 may provide light. The light module 172 may include a light-emitting diode or a xenon lamp. The light module 172 may operate in conjunction with the camera module 171 or operate independently.

The communication module 173 may support establishing a wired or wireless communication channel between the electronic device 101 and the external electronic device 102, and the performance of communication through the established communication channel. The communication module 173 may include one or both of a wireless communication module such as a cellular communication module, a short-range wireless communication module, or a global navigation satellite system (GNSS) communication module, and a wired communication module such as a local area network (LAN) communication module or a power line communication module. The communication module 173 may communicate with the external electronic device 102 through a short-range communication network such as Bluetooth, Wi-Fi direct, or infrared data association (IrDA), or a long-range communication network such as a cellular network, the Internet, or a computer network (for example, a LAN or WAN). The various types of communication modules 173 described above may be implemented as a single chip or may be implemented as separate chips.

The input module 130, the sensor module 191, the camera module 171, and the like may be used to control the operation of the display module 140 in conjunction with the processor 110.

The processor 110 may output the command or data to the display module 140, the audio output module 193, the camera module 171, or the light module 172 based on the input data received from the input module 130. For example, the processor 110 may generate the image data in response to the input data provided through a mouse or an active pen/stylus and output the image data to the display module 140, or may generate command data in response to the input data and output the command data to the camera module 171 or the light module 172. When the input data is not received from the input module 130 for a predetermined period of time, the processor 110 may change the operation mode of the electronic device 101 to a low power mode or sleep mode to reduce power consumption in the electronic device 101.

The processor 110 may output the command or data to the display module 140, the audio output module 193, the camera module 171, or the light module 172 based on sensing data received from the sensor module 191. For example, the processor 110 may compare authentication data provided by the fingerprint sensor 191-1 with the authentication data stored in the memory 180, and then execute an application according to the comparison result. The processor 110 may execute a command or output corresponding image data to the display module 140 based on sensing data detected by the input sensor 191-2 or the digitizer 191-3. When the sensor module 191 includes a temperature sensor, the processor 110 may receive temperature data about the temperature measured by the sensor module 191 and further perform luminance correction on the image data based on the temperature data.

The processor 110 may receive measurement data about the presence or absence of the user, the user's location, the user's gaze, and the like from the camera module 171. The processor 110 may further perform luminance correction on the image data based on the measurement data. For example, the processor 110, which determines the presence or absence of the user through input from the camera module 171, may output the image data whose luminance has been corrected by the data conversion circuit 112-2 or the gamma correction circuit 112-3 to the display module 140.

Some of the components described above may be connected to each other through a communication method between peripheral devices, for example, a bus, a general purpose input/output (GPIO), a serial peripheral interface (SPI), a mobile industry processor interface (MIPI), or an ultra-path interconnect (UPI) link to exchange a signal (for example, the command or data) with each other. The processor 110 may communicate with the display module 140 through a mutually agreed upon interface. For example, any one of the above-described communication methods may be used, and might not be necessarily limited to the above-described communication methods.

The electronic device 101 according to various embodiments disclosed herein may be various types of devices. The electronic device 101 may include, for example, at least one of a portable communication device (for example, a smart phone), a computer device, a portable multimedia device, a portable medical device, a camera, a wearable device, or a home appliance device. The electronic device 101 according to the embodiments disclosed in this specification is not necessarily limited to the above-described devices.

A display device, an electronic device, and a driving method thereof according to the embodiments of the present invention may compensate for stains with minimal power consumption.

Those skilled in the art will recognize that the present disclosure can be practiced in other specific ways without departing from its technical spirit or essential characteristics. Therefore, the described embodiments should be regarded as illustrative rather than being restrictive in all aspects. Although embodiments of the present disclosure have been described with reference to the accompanying drawings, the disclosure is not limited to these embodiments and may be implemented in various forms.

What is claimed is:

1. A display device, comprising:
a compensation value corrector circuit configured to calculate final compensation values by applying weights, based on input grayscales of an image frame, to reference compensation values; and
a timing controller circuit configured to generate output grayscales by applying the final compensation values to the input grayscales,
wherein the compensation value corrector circuit is configured to be switched-off based on the weights, and
wherein the output grayscales are set to be equal to the input grayscales when the compensation value corrector circuit is configured to be switched-off.

2. The display device of claim 1, wherein the compensation value corrector circuit includes:
a first weight calculator circuit configured to generate first weights based on an input brightness value.

3. The display device of claim 2, further comprising:
a memory, the memory including reference weights corresponding to reference brightness values,
wherein the first weight calculator circuit is configured to provide the reference weights corresponding to the input brightness value as the first weights, when the input brightness value is equal to any one of the reference brightness values, and
wherein, when the input brightness value is different from the reference brightness values, the first weight calculator circuit is configured to interpolate the reference weights corresponding to two of the reference brightness values closest to the input brightness value, and
wherein an interpolated value of the reference weights is provided as the first weights.

4. The display device of claim 3, wherein the compensation value corrector circuit further includes:
a second weight calculator circuit configured to calculate second weights based on the input grayscales and based on the first weights.

5. The display device of claim 4, wherein the first weights correspond to reference grayscales, respectively, and
wherein the second weight calculator circuit is configured to provide any one of the first weights corresponding to any one of the input grayscales as any one of the second weights, when any one of the input grayscales is equal to any one of the reference grayscales, and
wherein, when the input grayscales are different from the reference grayscales, the second weight calculator circuit is configured to interpolate the first weights corresponding to two of the reference grayscales closest to any one of the input grayscales, and
wherein an interpolated value of the first weights is provided as any one of the second weights.

6. The display device of claim 5, wherein the compensation value corrector circuit further includes:
a final compensation value calculator circuit configured to calculate the final compensation values by applying the second weights to the reference compensation values.

7. The display device of claim 6, wherein the compensation value corrector circuit further includes:
a switch-off trigger circuit configured to determine whether to switch-off the compensation value corrector circuit, based on the second weights.

8. The display device of claim 7, wherein the switch-off trigger circuit is configured to switch-off the compensation value corrector circuit when at least one of the second weights is less than or equal to a first reference value.

9. The display device of claim 8, wherein the compensation value corrector circuit further includes:
a counting circuit configured to count a number of the second weights that are less than or equal to the first reference value, and
a representative grayscale calculator circuit configured to calculate a representative grayscale of the input grayscales, and
wherein the counting circuit is configured to provide a count value, and
wherein the switch-off trigger circuit is configured to switch-off the compensation value corrector circuit when the count value is greater than a second reference value, and
wherein the switch-off trigger circuit is configured to switch-off the compensation value corrector circuit when any one of the second weights corresponding to the representative grayscale is less than or equal to the first reference value.

10. A driving method of a display device, comprising:
receiving an image frame including input grayscales;
calculating final compensation values by applying weights, based on the input grayscales, to reference compensation values;
generating output grayscales by applying the final compensation values to the input grayscales;
generating data voltages corresponding to the output grayscales; and
writing the data voltages into pixels,
wherein the calculating of the final compensation values is omitted based on the weights, and
wherein the output grayscales are set to be equal to the input grayscales, when the calculating of the final compensation values is omitted.

11. The driving method of claim 10, wherein the calculating of the final compensation values includes:
generating first weights based on an input brightness value.

12. The driving method of claim 11, wherein the calculating of the final compensation values further includes:
receiving reference weights corresponding to reference brightness values;
providing the reference weights corresponding to the input brightness value as the first weights, when the input brightness value is equal to any one of the reference brightness values; and
interpolating reference weights corresponding to two of the reference brightness values closest to the input brightness value, when the input brightness value is different from the reference brightness values, and providing an interpolated value of the reference weights as the first weights.

13. The driving method of claim 12, wherein the calculating of the final compensation values further includes:
calculating second weights based on the input grayscales and based on the first weights.

14. The driving method of claim 13, wherein the first weights correspond to reference grayscales, respectively, and
wherein the calculating of the final compensation values further includes:
providing any one of the first weights corresponding to any one of the input grayscales as any one of the second weights, when any one of the input grayscales is equal to any one of the reference grayscales; and
interpolating the first weights corresponding to two of the reference grayscales closest to any one of the input grayscales, when the input grayscales are different from the reference grayscales, and providing an interpolated value of the first weights as any one of the second weights.

15. The driving method of claim 14, wherein the calculating of the final compensation values further includes:
calculating the final compensation values by applying the second weights to the reference compensation values.

16. The driving method of claim 15, wherein the calculating of the final compensation values further includes:
determining whether to omit the calculating of the final compensation values, based on the second weights.

17. The driving method of claim 16, wherein the determining of whether to omit includes:
omitting the calculating of the final compensation values when at least one of the second weights is less than or equal to a first reference value.

18. The driving method of claim 17, wherein the calculating of the final compensation values includes:
providing a count value by counting a number of the second weights that are less than or equal to the first reference value, and
wherein the determining of whether to omit includes: omitting the calculating of the final compensation values when the count value is greater than a second reference value.

19. The driving method of claim 17, wherein the calculating of the final compensation values further includes:
calculating a representative grayscale of the input grayscales, and
wherein the determining of whether to omit includes:
omitting the calculating of the final compensation values when any one of the second weights corresponding to the representative grayscale is less than or equal to the first reference value.

20. An electronic device, comprising:
a processor configured to provide image frames including input grayscales; and
a display device configured to sequentially display the image frames received from the processor,
wherein the display device includes:
a compensation value corrector circuit configured to calculate final compensation values, by applying weights based on the input grayscales, to reference compensation values;
a timing controller circuit configured to generate output grayscales by applying the final compensation values to the input grayscales;
a data driver circuit configured to output data voltages corresponding to the output grayscales to data lines; and
a display panel including a plurality of pixels configured to receive the data voltages through the data lines,
wherein the compensation value corrector circuit is configured to be switched-off based on the weights, and
wherein the output grayscales are set to be equal to the input grayscales when the compensation value corrector circuit is switched-off.
